(19) United States
(12) Patent Application Publication
(10) Pub. No.: US 2006/0095520 A1
(43) Pub. Date: May 4, 2006

(54) Method and apparatus for managing computer systmes in multiple remote devices

(76) Inventor: Douglass J. Berg, Great Falls, VA (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/976,945

(22) Filed: Oct. 27, 2004

(51) Int. Cl. G06F 15/16

(52) U.S. Cl. 709/206

(57) ABSTRACT

A method and apparatus are provided for tracking compliance on multiple computer systems. A central database maintains compliance information on each of the multiple computer systems. Security notification messages are received and stored in the central database, each of the security notification messages including update information. A notice generator is coupled to the central database and determines which of the multiple computer systems requires the update information and generates notice messages in response to the security notification messages and the compliance information. The notice messages are provided to those of the multiple computer systems determined to require the update information.

### FIELD OF THE INVENTION

The present invention generally relates to networked computer systems, and more particularly relates to a method and apparatus for centrally monitoring noncompliance of multiple computer systems in remote devices by notifying managers of noncompliance and tracking the compliance thereof.

### BACKGROUND OF THE INVENTION

Information technology (IT) system administrators are typically responsible for repairing and updating numerous computer operating systems. For example, when computers are networked together and/or coupled to the world wide web, it is necessary to maintain the security of the computer systems by updating computers with software patches, known as security patches, provided to the system administrators for that purpose.

Keeping up to date with security patches is one of the biggest burdens for system administrators. First, it is a burden just to keep up to date with all of the system vulnerabilities. Software and hardware vendors release vulnerability reports; different Computer Emergency Response Teams (CERTs) release vulnerability reports; and third party organizations release vulnerability notifications. Second, it is a burden to have security patches installed on multiple computer machines. Some system administrators are co-located with the computers they service; other system administrators are responsible for multiple computer systems in various locations.

While keeping abreast of security patches is a burden, installation of many of these patches is imperative. Thus, it is necessary for system administrators to know the current compliance states of the computers for which they are responsible. Accordingly, it is desirable to have a mechanism for notifying managers of noncompliance of multiple computer systems in remote devices and for managers to track the compliance of those computer systems. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A compliance tracking system for tracking compliance on multiple computer systems is provided for which includes a central database, a notice generator, a compliance updater, an input and an output. The central database maintains compliance information on each of the multiple computer systems. The input receives security notification messages and stores the security notification messages in the central database, each of the security notification messages including update information. The notice generator is coupled to the central database and determines which of the multiple computer systems requires the update information. The notice generator also generates notice messages in response to the security notification messages and the compliance information. The output is coupled to the notice generator to provide the notice messages to those of the multiple computer systems determined to require the update information.

A method for tracking compliance on multiple computer systems where compliance information on each of the multiple computer systems is maintained in a central database is also provided. The method includes the steps of receiving a security notification message including update information, determining from the security notification message and the compliance information in the central database which of the multiple computer systems requires the update information, generating a notice message comprising the update information, and providing the notice message to those of the multiple computer systems determined to require the update information.

### BRIEF DESCRIPTION OF THE DRAWINGS

The present invention will hereinafter be described in conjunction with the following drawing figures, wherein like numerals denote like elements, and

FIG. 1 is a block diagram of the compliance tracking system in accordance with the preferred embodiment of the present invention; and

FIG. 2 is a flowchart of the operation of the compliance tracking system in accordance with the preferred embodiment of the present invention.

### DETAILED DESCRIPTION OF THE INVENTION

The following detailed description of the invention is merely exemplary in nature and is not intended to limit the invention or the application and uses of the invention. Additionally, while the detailed description describes a compliance tracking system for the United States Department of Defense, the invention or the application and uses of the invention are not limited to this particular implementation or even limited to similar implementations. Furthermore, there is no intention to be bound by any theory presented in the preceding background of the invention or the following detailed description of the invention.

To address the volume of vulnerability reports received from various sources and reduce the burden on its system administrators, the Department of Defense developed the Information Assurance Vulnerability Alerts (IAVA), reports which forward security patches to system administrators. An IAVA describes the vulnerability, lists the operating systems or applications that are vulnerable, lists required action items, provides the security patches or internet links to obtain the security patches, and provides compliance date information which indicates a date by which all computer systems should be in compliance (i.e., the security patches, if required, should be installed).

Each organization receiving an IAVA must ensure that their computer systems are within IAVA compliance. This duty falls upon the security administrators for that organization. For small organizations with only a few system administrators, coming within compliance is a relatively easy task. However, for large organizations or decentralized organizations having multiple, remotely-located computer systems, coming within compliance can be a difficult task.

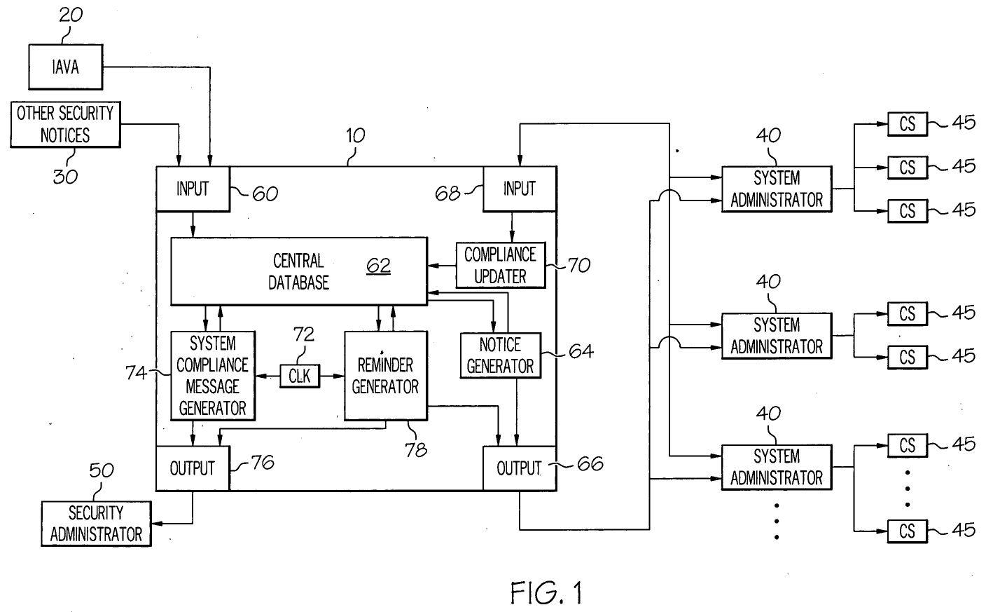

Referring to FIG. 1, in accordance with the present invention the compliance tracking system 10 can receive IAVA security notification messages from the Department of Defense 20. In addition, the compliance tracking system 10 may receive security notification messages from non-Department of Defense sources 30. The compliance tracking system 10 is coupled to system administrators 40 for multiple computer systems 45 at remote locations for emailing information to the system administrators 40 and for receiving compliance information emails therefrom. The compliance tracking system 10 is also coupled to a security administrator 50 who is responsible for overseeing the compliance of all of the multiple computer systems in the organization.

The compliance tracking system 10 of the present invention receives security notification messages from IAVA 20 and other sources 30 at a first input 60. These security notification messages, like the IAVAs, include update information and compliance date information. The update information includes a listing of the operating systems or applications that are vulnerable and required actions. In addition, the update information provides the security patches or internet links to obtain the security patches. The compliance date information indicates a date by which all computer systems should be in compliance.

In accordance with the preferred embodiment of the present invention, the first input is coupled to a central database 62 which maintains compliance information on all of the multiple computer systems 45, including identification of the hardware and software of each computer system 45, identification of the system administrator 40 responsible for that computer system 45, and information on the current compliance state of each computer system 45. When an IAVA or other security notification message is received by the first input 60, the security notification message is stored in the central database 62. A notice generator 64 is coupled to the central database and, in response to storage of a security notification message in the central database 62, reviews the compliance information on the multiple computer systems 45 to determine which of the multiple computer systems 45 requires the update information. The notice generator 64 then generates notice messages for the system administrators 40. The notice messages are generated in response to the contents of the security notification message and the compliance information such that the notice messages provide the necessary information to the system administrators 40 to identify which computer systems 45 require the update information (e.g., security patches) as well as notifying the system administrators 40 of the compliance date information. The notice generator 64 provides the notice messages to a first output 66 of the compliance tracking system 10 which emails the notice messages to the system administrators 40.

The system administrators 40 receive the notice messages and are responsible for updating the multiple computer systems 45. In accordance with the preferred embodiment of the present invention, the notice messages advantageously provide the system administrators 40 with specific information identifying which of the computer systems 45 require updating and either provides the appropriate security patches or provides internet links to the appropriate security patches. In this manner, the present invention improves the response time of the security administrator 50 and the system administrators 40 to take corrective action in response to security notification messages by automatically generating computer-specific notice messages which provide all necessary update information, such as security patches, to take the necessary corrective measures.

A further improvement of the present invention is that the compliance tracking system 10 will track how many computer systems 45 have been patched and which ones still need attention. After receiving the notice messages, the system administrators 40 log into the compliance tracking system 10 and provide updated compliance information on the multiple computer systems 45 to a second input 68. The updated compliance information is provided to a compliance updater 70 which is coupled to the central database 62 for updating the compliance information in the central database 62 in response to the updated compliance information. To determine which computer systems 45 still need attention, the compliance tracking system 10 includes a clock 72. Each security notification message has a date which is stored in the central database 62. When the notice messages are sent compliance date information is sent which indicates the date that all computer systems 45 should be in compliance. This date is a predetermined number of days after the date of the security notification message, typically thirty days. A system compliance message generator 74 is coupled to the clock 72 and the central database 62. A predetermined number of days before the date that all computer systems 45 should be in compliance (typically five days), the system compliance message generator 74 generates a system compliance message indicating which of the multiple computer systems 45 is not in compliance. This system compliance message is sent to the security administrator 50 via a second output 76 of the compliance tracking system 10. The security administrator 50 is responsible for compliance of the multiple computer systems 45 and, after receiving the system compliance message, can take appropriate action to assure that all of the computer systems 45 are in compliance before the chosen date.

An additional advantage of the present invention tracking how many computer systems 45 have been patched and which ones still need attention is a reminder generator 78 coupled to the central database 62 which determines reminder times in response to the security notification message. In accordance with the preferred embodiment of the present invention, the reminder times are each week after receiving the security notification message. The reminder generator 78 is coupled to the clock 72 and, at the reminder times, reviews the compliance information in the central database 62 to determine noncomplying ones of the multiple computer systems 45. The reminder generator 78 then provides a reminder message email via the first output 66 to the noncomplying ones of the multiple computer systems 45. The reminder generator may also be advantageously coupled to the second output 76 for providing the reminder messages to the security administrator 50 for tracking compliance of the multiple computer systems 45.

It is easily understood by one skilled in the art that the present invention allows the security administrator to track compliance of the multiple computer systems 45 and to quickly provide pertinent information to the system administrators 40 to reduce confusion and delay in complying with important security notifications.

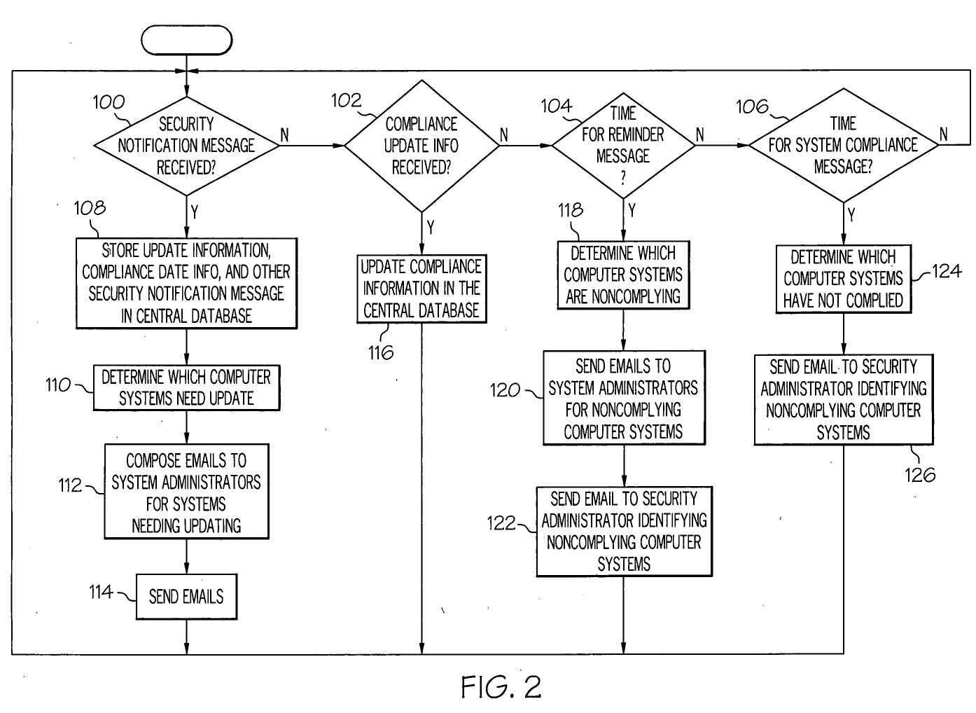

Referring to FIG. 2, a flowchart of the operation of the present invention is shown. The preferred embodiment of the present invention enables the compliance tracking system 10 in software in an information handling system such as a computer. The compliance tracking system 10 receives security notification messages, preferably as emails, from outside sources 20, 30, and receives updated compliance information from the system administrators 40, preferably by the system administrators 40 logging into the compliance tracking system 10 via the internet. The compliance tracking system 10 also automatically generates the notice messages, system compliance messages and reminder messages as emails and sends them via the internet to the system administrators 40 and/or the security administrator 50.

In operation, the compliance tracking system 10 first determines whether a security notification message has been received 100, whether a system administrator 40 has logged in and provided compliance update information 102, whether it is time for reminder messages to be emailed 104, or whether it is time for a system compliance message to be emailed 106.

When a security notification message has been received 100, the security notification message including update information and compliance date information is stored 108 in the central database 62 and it is determined 110 from the security notification message and the compliance information stored in the central database 62 which of the multiple computer systems 45 require the update information. Notice messages are then generated by composing 112 emails to the system administrators 40 identifying which of the computer systems 45 require updating, the emails including the update information and the compliance date information. The notice messages are then provided to the system administrators 40 for the computer systems 45 by sending the emails 114 thereto and processing then returns to await the next event 100, 102, 104, 106.

When compliance update information is received 102 from a system administrator 40, the central database 62 is updated by updating 116 the compliance information therein in response to the updated compliance information received from the system administrators 40. Processing then returns to await the next event 100, 102, 104, 106.

When it is determined from the clock 72 and the compliance date information in the security notification message that it is a reminder time 104, the central database 62 is examined to determine from the compliance information in the central database 62 which computer systems 45 are noncomplying 118. A reminder message is then sent 120 to the system administrators 40 responsible for the noncomplying ones of the multiple computer systems 45 informing the system administrators of noncompliance and reminding the system administrators of the compliance date. In addition, an email may be sent 122 to the security administrator 50 listing the noncomplying ones of the multiple computer systems 45. In accordance with the preferred embodiment of the present invention, all of the multiple computer systems 45 should be in compliance within thirty days of receiving the security notification messages and the reminder messages are sent weekly. Processing then returns to await the next event 100, 102, 104, 106.

When it is determined from the clock 72 and the compliance date information in the security notification message that it is a time to send a system compliance message 106, a system compliance message is generated indicating which of the multiple computer systems 45 is not in compliance 124. The compliance date information in the security notification message is typically thirty days such that all of the multiple computer systems 45 should be in compliance within thirty days of receiving the security notification messages. In accordance with the preferred embodiment of the present invention, the time for the system compliance message is five days before the end of the thirty day compliance period. The system compliance message is then provided to the security administrator 50 by sending an email indicating which of the multiple computer systems is not in compliance 126 so that the security administrator 50 can take appropriate action to assure compliance of all of the multiple computer systems 45 within the compliance period. Processing then returns to await the next event 100, 102, 104, 106.

Thus it can be seen that a compliance tracking system has been provided for notifying system administrators and security administrators of noncompliance of multiple computer systems in remote devices and for tracking the compliance of those computer systems. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for tracking compliance on multiple computer systems where compliance information on each of the multiple computer systems is maintained in a central database, the method comprising the steps of:
receiving a security notification message including update information;
determining from the security notification message and the compliance information in the central database which of the multiple computer systems requires the update information;
generating a notice message comprising the update information; and
providing the notice message to those of the multiple computer systems determined to require the update information.

2. The method of claim 1 further comprising the steps of:
receiving updated compliance information from the multiple computer systems; and
updating the compliance information in the central database in response to the updated compliance information.

3. The method of claim 1 wherein the security notification message comprises compliance date information indicating a date by which all of the multiple computer systems should be in compliance, and
wherein the step of generating the notice message comprises the step of generating the notice message comprising the compliance date information.

4. The method of claim 3 further comprising the steps of:
generating a system compliance message at a time determined in response to the compliance date information, the system compliance message indicating which of the multiple computer systems is not in compliance at said time; and
providing the system compliance message to a system administrator responsible for compliance of the multiple computer systems.

5. The method of claim 4 wherein the compliance date information comprises a first predetermined number of days and a date of the security notification message, and wherein the time is a second predetermined number of days less than the first predetermined number of days after the date of the security notification message.

6. The method of claim 5 wherein the first predetermined number of days is thirty days.

7. The method of claim 5 wherein the second predetermined number of days is five days.

8. The method of claim 1 further comprising the step of:
determining a reminder time in response to the security notification message; and
at the reminder time providing a reminder message to noncomplying ones of the multiple computer systems, the noncomplying ones of the multiple computer systems determined in response to the compliance information in the central database.

9. A system for tracking compliance on multiple computer systems comprising:
a central database for maintaining compliance information on each of the multiple computer systems;
a first input for receiving security notification messages, each of the security notification messages comprising update information, the first input coupled to the central database for storing the security notification messages therein;
a notice generator coupled to the central database for determining which of the multiple computer systems requires the update information and for generating notice messages in response to the security notification messages and the compliance information, the notice messages comprising the update information; and
a first output coupled to the notice generator for providing said notice messages to those of the multiple computer systems determined to require the update information.

10. The system of claim 9 further comprising:
a second input for receiving updated compliance information from the multiple computer systems; and
a compliance updater coupled to the second input and the central database for updating the compliance information in the central database in response to the updated compliance information.

11. The system of claim 9 wherein each of the security notification messages comprises compliance date information indicating a date by which all of the multiple computer systems should be in compliance, and wherein the notice generator generates notice messages comprising the compliance date information.

12. The system of claim 11 further comprising:
a clock for providing current time information;
a system compliance message generator coupled to the central database and the clock for generating a system compliance message at a time determined in response to the compliance date information and the current time information, the system compliance message indicating which of the multiple computer systems is not in compliance at said time; and
a second output coupled to the system compliance message generator for providing the system compliance message to a system administrator responsible for compliance of the multiple computer systems.

13. The system of claim 12 wherein the compliance date information comprises a first predetermined number of days and a date of the security notification message, and wherein the time is a second predetermined number of days less than the first predetermined number of days after the date of the security notification message.

14. The system of claim 13 wherein the first predetermined number of days is thirty days.

15. The system of claim 13 wherein the second predetermined number of days is five days.

16. The system of claim 9 further comprising a reminder generator coupled to the clock and the central database for determining a reminder time in response to the security notification message, and wherein the reminder generator is further coupled to the first output and the central database for providing a reminder message to noncomplying ones of the multiple computer systems at the reminder time, the noncomplying ones of the multiple computer systems determined in response to the compliance information in the central database.
